(19) United States
(12) Patent Application Publication
(10) Pub. No.: US 2012/0068987 A1
(43) Pub. Date: Mar. 22, 2012

(54) PLASMA DISPLAY PANEL DRIVE METHOD AND PLASMA DISPLAY DEVICE

(75) Inventor: Yutaka Yoshihama, Osaka (JP)

(73) Assignee: Panasonic Corporation, Osaka (JP)

(21) Appl. No.: 13/264,044

(22) PCT Filed: Jun. 8, 2010
(86) PCT No.: PCT/JP2010/003793

§ 371 Date: Oct. 12, 2011

(30) Foreign Application Priority Data
Jun. 10, 2009 (JP) 2009-138880

(51) Int. Cl. G09G 5/00; G09G 3/28

(52) U.S. Cl. 345/211; 345/60

(57) ABSTRACT

In the driving method of a plasma display panel, one field contains a plurality of subfields and each of which has the following periods: an address period for generating an address discharge; a sustain period where a voltage is applied to data electrodes and sustain pulses corresponding to luminance weight are applied to scan electrodes and sustain electrodes for generating a sustain discharge; and an erase period where a voltage is applied to the scan electrodes and the sustain electrodes for generating an erase discharge. The erase discharge is generated selectively in the discharge cell having undergone an address discharge in the immediately preceding address period. In the sustain period of at least one of the subfields, a voltage to be applied to the data electrodes of the discharge cells having green phosphors is lower than that to be applied to the data electrodes of the discharge cells having red phosphors.

### TECHNICAL FIELD

The present invention relates to a driving method of an AC surface discharge plasma display panel and also relates to a plasma display device.

### BACKGROUND ART

A plasma display panel (hereinafter, simply referred to a panel) has a plurality of discharge cells having scan electrodes, sustain electrodes, and data electrodes. In the panel, a gas discharge occurs in each discharge cell and generates ultraviolet rays, which excite phosphors to emit light of red color, green color, and blue color. The panel thus offers color display.

Generally, the panel is driven by a subfield method where one field is formed of a plurality of subfields each of which having an initializing period, an address period, and a sustain period. According to the subfield method, gradation display on the panel is attained by combination of the subfields to be lit. In each subfield, the initializing period has initializing operation, the address period has address operation, and the sustain period has sustain operation. The initializing operation generates an initializing discharge to form wall charge necessary for the address operation that follows the initializing operation. The initializing operation has following two types: an all-cell initializing operation in which the initializing discharge is generated in all of the discharge cells with no regard to operation of the immediately preceding subfield; and a selective-cell initializing operation in which the initializing discharge is generated in a discharge cell having undergone an address discharge in the immediately preceding subfield. The address operation generates an address discharge selectively in a discharge cell and forms wall charge according to image to be displayed on the panel. The sustain operation applies sustain pulses alternately to the display electrode pair to generate a sustain discharge in a discharge cell so that the phosphor layer of the cell emits light. The light emission of the phosphor layer by the sustain discharge contributes to gradation display. In other words, light emission other than by the sustain discharge has no contribution to gradation display.

In the subfield methods, some suggestions on improvement in contrast have been made. According to a method, reducing the luminance of black color as the lowest level in gradation display (hereinafter, luminance of black level) and minimizing the light emission with no contribution to gradation display allows image display to have sharp contrast. For example, Patent Literature 1 introduces a method in which the all-cell initializing operation is limited to once in one field and ramp waveform voltage with a gradual change is employed for the all-cell initializing operation.

Patent Literature 2 discloses a driving method having further improvement in contrast. According to the method, the display electrode pairs are divided into ‘n’ groups and the all-cell initializing operation is carried out once every ‘n’ fields, at the same time, the luminance of black level is further reduced by further decrease in light emission with no contribution to gradation display.

However, even by the methods described in Patent Literatures 1 and 2, light emission with no contribution to gradation display is unavoidable as long as the all-cell initializing operation is carried out. This means that even a discharge cell responsible for displaying black has light emission, which has imposed limitations on improvement in contrast. The all-cell initializing operation has important roles: accumulating wall charge necessary for generating an address discharge in the next address period; and generating priming that decreases time of discharge delay so as to generate an address discharge with reliability. Therefore, omission of the all-cell initializing operation invites some problems, such as no address discharge and unstable address operation due to increase in time of discharge delay in address discharge, resulting in poor image display. As another problem, variations in discharge characteristics of each discharge cell cannot be absorbed, which narrows the setting margin of driving voltage.

### [Citation List]

### [Patent Literature]

[Patent Literature 1]

Unexamined Japanese Patent Publication No. 2000-242224

[Patent Literature 2]

Unexamined Japanese Patent Publication No. 2006-091295

### SUMMARY OF THE INVENTION

The present invention provides a driving method of a panel and a plasma display device capable of offering stable address operation and improvement in contrast, without an all-cell initializing operation, by eliminating variations in the setting range of driving voltage to each discharge cell so as to broaden the setting margin of the driving voltage.

The present invention disclosed here is a driving method of a panel with a plurality of discharge cells each of which having a scan electrode, a sustain electrode, a data electrode, and a phosphor emitting light of red, green, or blue color. In the method, one field is formed of a plurality of subfields, and each of the subfields has an address period, a sustain period, and an erase period. In the address period, scan pulses are applied to the scan electrodes and address pulses are applied to the data electrodes for generating an address discharge. In the sustain period, a voltage is applied to the data electrodes and sustain pulses corresponding to luminance weight are applied alternately to the scan electrodes and the sustain electrodes for generating a sustain discharge. In the erase period, a predetermined voltage is applied to the scan electrodes and the sustain electrodes for generating an erase discharge. The erase discharge is generated selectively in a discharge cell having undergone the address discharge in the immediately preceding address period. In the sustain period of at least any one of the subfields, the voltage to be applied to the data electrodes disposed at the discharge cells having green phosphors is lower than that to be applied to the data electrodes disposed at the discharge cells having red phosphors. The method eliminates variations in setting range of driving voltage to each discharge cell, broadening the setting margin of the driving voltage. At the same time, in the method, the all-cell initializing operation is omitted so as to eliminate light emission with no contribution to gradation display. This allows a panel to have drastic improvement in contrast, with the stability of address operation maintained.

As another aspect, the method of the present invention is a driving method of a panel with a plurality of discharge cells each of which having a scan electrode, a sustain electrode, and a data electrode. In the method, one field is formed of a plurality of subfields, and each of the subfields has an address period, a sustain period, and an erase period. In the address period, scan pulses are applied to the scan electrodes and address pulses are applied to the data electrodes for generating an address discharge. In the sustain period, a voltage is applied to the data electrodes and sustain pulses corresponding to luminance weight are applied alternately to the scan electrodes and the sustain electrodes for generating a sustain discharge. In the erase period, a voltage is applied to the scan electrodes and the sustain electrodes for generating an erase discharge. The erase discharge is generated selectively in a discharge cell having undergone the address discharge in the immediately preceding address period. The voltage to be applied to the data electrodes in the sustain period of the subfield having the minimum luminance weight is lower than that to be applied to the data electrodes in the sustain period of each subfield except for the subfield having the minimum luminance weight. The method eliminates variations in setting range of driving voltage to each discharge cell, broadening the setting margin of the driving voltage. At the same time, in the method, the all-cell initializing operation is omitted so as to eliminate light emission with no contribution to gradation display. This allows a panel to have drastic improvement in contrast, with the stability of address operation maintained.

The driving method of a panel of the present invention has an aspect below. In the sustain period of the subfield having the minimum luminance weight, the voltage to be applied to the data electrodes disposed at the discharge cells having green phosphors may be lower not only than that to be applied to the data electrodes disposed at the discharge cells having red phosphors, but also than that to be applied to the data electrodes in the sustain period of each subfield except for the subfield having the minimum luminance weight.

The plasma display device of the present invention has a panel with a plurality of discharge cell each of which having a scan electrode, a sustain electrode, a data electrode, and a phosphor emitting light of red, green, or blue color, and has a driver circuit. The driver circuit generates diving voltage waveforms and applies them to each electrode of the panel, driving the panel on the subfield structure where one field is formed by a plurality of subfields. Each of the subfields has an address period, a sustain period, and an erase period. In the address period, scan pulses are applied to the scan electrodes and address pulses are applied to the data electrodes for generating an address discharge. In the sustain period, a voltage is applied to the data electrodes and sustain pulses corresponding to luminance weight are applied alternately to the scan electrodes and the sustain electrodes for generating a sustain discharge. In the erase period, a voltage is applied to the scan electrodes and the sustain electrodes for generating an erase discharge. In the erase period, the driver circuit generates an erase discharge selectively in a discharge cell having undergone the address discharge in the immediately preceding address period. At the same time, in the sustain period of at least one of the subfields, the driver circuit controls a voltage to be applied to the data electrodes disposed at the discharge cells having green phosphors so as to be lower than that to be applied to the data electrodes disposed at the discharge cells having red phosphors. The structure eliminates variations in setting range of driving voltage to each discharge cell, broadening the setting margin of the driving voltage. At the same time, in the structure, the all-cell initializing operation is omitted so as to eliminate light emission with no contribution to gradation display. This allows a panel to have drastic improvement in contrast, with the stability of address operation maintained.

As another aspect, the plasma display device of the present invention has a panel with a plurality of discharge cells each of which having a scan electrode, a sustain electrode, and data electrode, and has a driver circuit. The driver circuit generates diving voltage waveforms and applies them to each electrode of the panel, driving the panel on the subfield structure where one field is formed by a plurality of subfields. Each of the subfields has an address period, a sustain period, and an erase period. In the address period, scan pulses are applied to the scan electrodes and address pulses are applied to the data electrodes for generating an address discharge. In the sustain period, a voltage is applied to the data electrodes and sustain pulses corresponding to luminance weight are applied alternately to the scan electrodes and the sustain electrodes for generating a sustain discharge. In the erase period, a voltage is applied to the scan electrodes and the sustain electrodes for generating an erase discharge. In the erase period, the driver circuit generates an erase discharge selectively in a discharge cell having undergone the address discharge in the immediately preceding address period. At the same time, the driver circuit controls a voltage to be applied to the data electrodes in the sustain period of the subfield having the minimum luminance weight so as to be lower than that applied to the data electrodes in the sustain period of each subfield except for the subfield having the minimum luminance weight. The structure eliminates variations in setting range of driving voltage to each discharge cell, broadening the setting margin of the driving voltage. At the same time, in the structure, the all-cell initializing operation is omitted so as to eliminate light emission with no contribution to gradation display. This allows a panel to have drastic improvement in contrast, with the stability of address operation maintained.

As described above, the structure eliminates variations in setting range of driving voltage to be applied to each discharge cell, broadening the setting margin of the driving voltage. The panel driving method and the plasma display device of the invention provide stable address operation without all-cell initializing operation, offering drastic improvement in contrast.

### BRIEF DESCRIPTION OF DRAWINGS

FIG. 1 is an exploded perspective view showing a plasma display device in accordance with first exemplary embodiment of the present invention.

FIG. 2 shows an electrode layout of the plasma display device.

FIG. 3 shows waveforms of driving voltage to be applied to each electrode of the plasma display device.

FIG. 4 is a view illustrating how a first, a second, and a third voltages are determined.

FIG. 5 shows a simple approach to measuring discharge start voltage.

FIG. 6 is a circuit block diagram of the plasma display device in accordance with first exemplary embodiment of the present invention.

FIG. 7 is a circuit diagram of the scan electrode driver circuit of the plasma display device.

FIG. 8 is a circuit diagram of the sustain electrode driver circuit of the plasma display device.

FIG. 9 is a circuit diagram of the data electrode driver circuit of the plasma display device.

FIG. 10 shows the waveforms of driving voltage to be applied to each electrode in the first field of the plasma display device in accordance with second exemplary embodiment of the present invention.

FIG. 11 shows the waveforms of driving voltage to be applied to each electrode in the second field of the plasma display device in accordance with second exemplary embodiment of the present invention.

### DETAILED DESCRIPTION OF PREFERRED EMBODIMENTS

The plasma display device of the exemplary embodiments of the present invention is described hereinafter with reference to the accompanying drawings.

### First Exemplary Embodiment

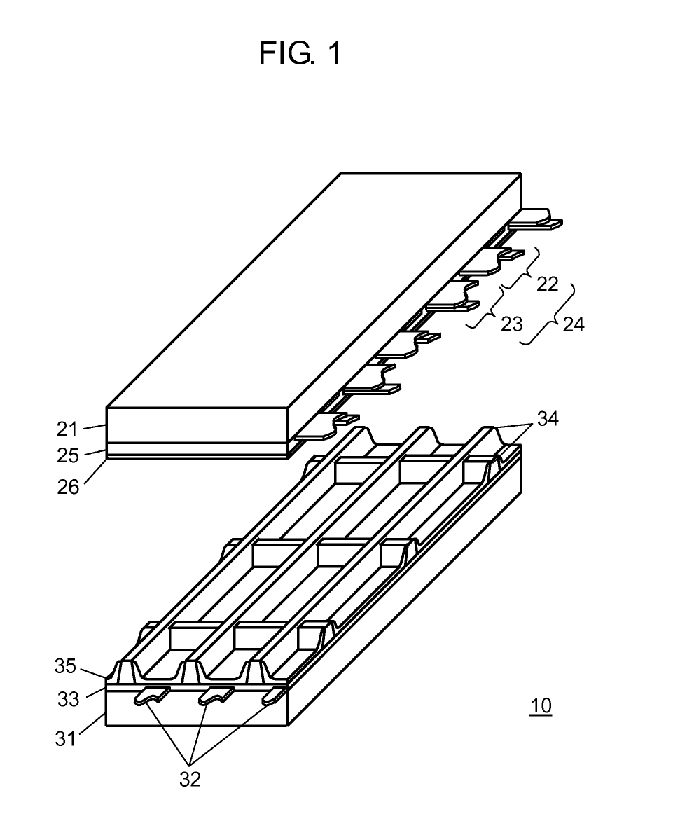

FIG. 1 is an exploded perspective view showing panel 10 of the plasma display device in accordance with first exemplary embodiment of the present invention. On glass-made front substrate 21, display electrode pairs 24, each of which is formed of scan electrode 22 and sustain electrode 23, are arranged, and over which, dielectric layer 25 and protective layer 26 are formed to cover display electrode pairs 24. Protective layer 26 is made of magnesium oxide as a material having high electron emission for encouraging generation of discharge. On rear substrate 31, data electrodes 32 are disposed, and over which, dielectric layer 33 is formed to cover data electrodes 32. On dielectric layer 33, barrier rib 34 is formed in a grid arrangement. Phosphor layer 35, which emits light in red, green and blue colors, is formed on the side surfaces of barrier rib 34 and on dielectric layer 33. For example, a red phosphor mainly contains (Y, Gd)BO₃:Eu, a green phosphor mainly contains Zn₂SiO₄:Mn, and a blue phosphor mainly contains BaMgA₁₀O₁₇:Eu.

Front substrate 21 and rear substrate 31 are oppositely disposed in a manner that display electrode pairs 24 are placed orthogonal to data electrodes 32 in a narrow discharge space between the two substrates. The two substrates are sealed at the peripheries with a sealing material such as glass frit. The discharge space is filled with discharge gas, for example, a mixture gas of neon and xenon. The discharge space is divided into sections by barrier rib 34. Discharge cells are formed at intersections of display electrode pairs 24 and data electrodes 32. A discharge is generated in the discharge cells to emit light, so that the panel displays image.

Panel 10 does not necessarily have the structure above; the barrier rib may be formed into stripes.

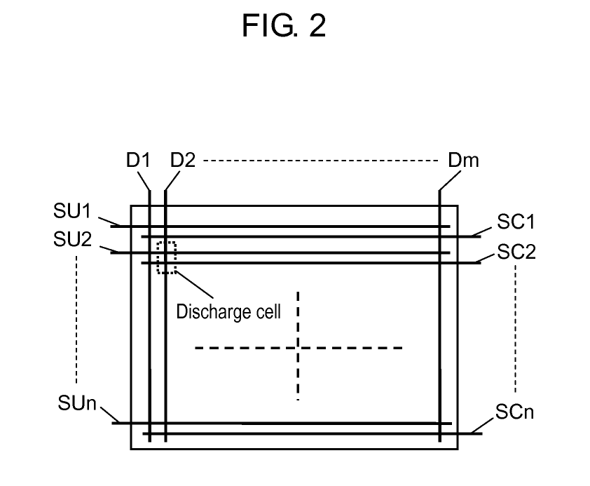

FIG. 2 shows an electrode layout of panel 10 used for the plasma display device in accordance with first exemplary embodiment. In the horizontal direction, panel 10 has ‘n’ long scan electrode SC1 through scan electrode SCn (corresponding to scan electrodes 22 in FIG. 1) and ‘n’ long sustain electrode SU1 through sustain electrode SUn (corresponding to sustain electrodes 23 in FIG. 1). In the vertical direction, panel 10 has ‘m’ long data electrode D1 through data electrode Dm (corresponding to data electrodes 32 in FIG. 1). A discharge cell is formed at an intersection of a pair of scan electrode SCi and sustain electrode SUi (i=1 to n) and data electrode Dj (j=1 to m). That is, panel 10 contains m×n discharge cells in the discharge space.

Next, the driving voltage waveform for driving panel 10 and the workings of the driving voltage will be described. The plasma display device employs a subfield method for image display. In the subfield method, one field is divided into a plurality of subfields, and light-emitting control of each discharge cell is carried out on a sub-field basis.

According to the embodiment, each subfield has an address period, a sustain period, and an erase period. An all-cell initializing operation—by which initializing discharge occurs in all discharge cells with no regard to having undergone discharge or not—is not carried out.

The address period is responsible for carrying out address operation. Specifically, an address discharge is generated selectively in a discharge cell to be lit and wall charge is formed. The sustain period is responsible for carrying out sustain operation. That is, sustain pulses corresponding to luminance weight predetermined to each subfield are applied alternately between the scan electrode and the sustain electrode of the display electrode pair. The application of sustain pulses generates a sustain discharge in a discharge cell having undergone the address discharge and excites phosphors for light emission. The sustain period may be omitted to lower the luminance of light emission. The erase period is responsible for carrying out erase operation. The erase operation generates an erase discharge selectively in a discharge cell having undergone an address discharge in the immediately preceding address period. The erase discharge erases the history of wall charges that have been formed by the preceding address discharge or the sustain discharge that follows the address discharge and then forms wall charges required for the address discharge. As an example of the subfield structure, one field is divided into ten subfields (subfield SF1, subfield SF2, . . . , subfield SF10), each of which has luminance weight as follows: 1, 2, 3, 6, 11, 18, 30, 44, 60, and 80. However, the present invention is not limited to the subfield structure above in terms of the number of the subfields and luminance weight.

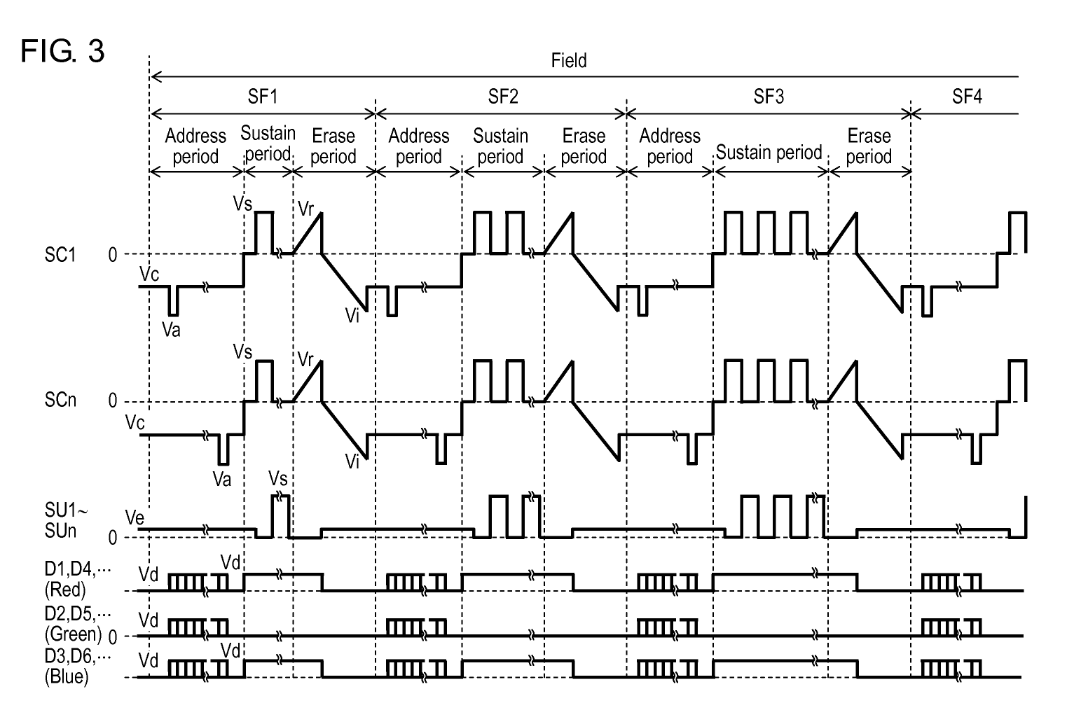

FIG. 3 shows the waveforms of driving voltage applied to each electrode of plasma display device of first exemplary embodiment.

In the address period of subfield SF1, voltage 0(V) is applied to data electrode D1 through data electrode Dm, voltage Ve is applied to sustain electrode SU1 through sustain electrode SUn, and voltage Vc is applied to scan electrode SC1 through scan electrode SCn. Next, scan pulse voltage Va is applied to scan electrode SC1 located in the first row, and address pulse voltage Vd is applied to data electrode Dk disposed at the discharge cell to be lit in the first row.

At this time, difference in voltage at the intersection of data electrode Dk and scan electrode SC1 is calculated by adding positive wall voltage on data electrode Dk to the difference in voltage applied from outside (i.e., Vd-Va). The calculated value exceeds the discharge start voltage, thereby generating an address discharge between data electrode Dk and scan electrode SC1. The discharge further causes an address discharge between scan electrode SC1 and sustain electrode SU1. Through the address discharge, positive wall voltage is built up on scan electrode SC1, while negative wall voltage is built up on sustain electrode SU1 and data electrode Dk. In the description, the wall voltage on each electrode represents a voltage generated by wall charges built up on the dielectric layer, the protective layer and the phosphor layer on the electrodes.

In the address operation, as described above, an address discharge is generated so as to build up wall voltage on each electrode in a discharge cell to be lit in the first row. In contrast, the voltage at the intersection of scan electrode SC1 and the data electrode Dh with no application of address pulse voltage Vd is lower than discharge start voltage VFds, and therefore no address discharge is generated.

Next, scan pulses are applied to scan electrode SC2 in the second row, and address pulses are applied to data electrode Dk corresponding to the discharge cell to be lit in the second row. The application of the pulses generates address discharge between data electrode Dk and scan electrode SC2, and between sustain electrode SU2 and scan electrode SC2. Through the address discharge, positive wall voltage is built up on scan electrode SC2, while negative wall voltage is built up on sustain electrode SU2 and data electrode Dk. In this way, an address discharge is generated so as to build up wall voltage on each electrode in a discharge cell to be lit in the second row. In contrast, the voltage at the intersection of scan electrode SC2 and the data electrode Dh with no application of address pulse voltage Vd is lower than discharge start voltage VFds, and therefore no address discharge is generated.

As for the rest of the scan electrodes, the address operation is carried out in the same manner until scan electrode SCn located in the n^{th} row.

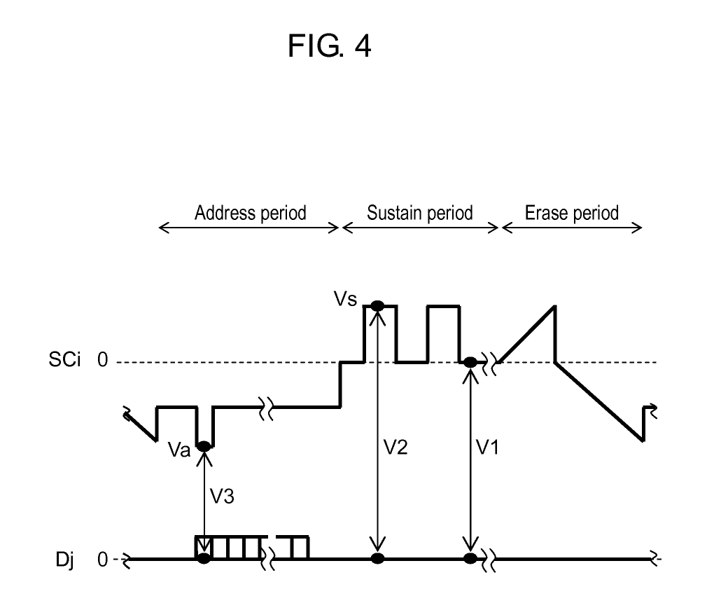

For the sake of understanding the description below, first voltage V1, second voltage V2, third voltage V3 are defined as shown in FIG. 4. First voltage V1 is calculated by subtracting a voltage applied to data electrode Dj from a voltage on the low voltage side of sustain pulses applied to scan electrode SCi in the sustain period that will be described later. Second voltage V2 is calculated by subtracting a voltage applied to data electrode Dj from a voltage on the high voltage side of sustain pulses applied to scan electrode SCi in the sustain period. Third voltage V3 is calculated by subtracting a voltage on the low voltage side of data pulses applied to data electrode Dj from a voltage on the low voltage side of scan pulses applied to scan electrode SCi in the address period.

Further, discharge start voltage is determined as follows. The discharge start voltage at the discharge between data electrode Dj as the anode and scan electrode SCi as the cathode is defined as discharge start voltage VFds, whereas the discharge start voltage at the discharge between data electrode Dj as the cathode and scan electrode SCi as the anode is defined as discharge start voltage VFsd. A discharge between data electrode Dj as the anode and scan electrode SCi as the cathode is the discharge generated under the state where data electrode Dj is positioned on the high electric-potential side and scan electrode SCi is positioned on the low electric-potential side in the electric field of a discharge cell having discharge. In contrast, a discharge between data electrode Dj as the cathode and scan electrode SCi as the anode is the discharge generated under the state where data electrode Dj is positioned on the low electric-potential side and scan electrode SCi is positioned on the high electric-potential side in the electric field of a discharge cell having discharge. Protective layer 26, which is made of magnesium oxide with high electron emission, is formed on the side of scan electrode SCi. This allows discharge start voltage VFds to be lower than discharge start voltage VFsd.

In the description above, voltage Va to be applied to scan electrode SCi is determined so as to satisfy the following two conditions for all of the discharge cells:

(V1−V3)≧VFds, Condition 1

that is, a voltage calculated by subtracting third voltage V3 from first voltage V1 equals to voltage VFds or greater.

(V2−V3)≦(VFds+Vfsd),Condition 2

that is, a voltage calculated by subtracting third voltage V3 from second voltage V2 is not greater than the total of discharge start voltage

VFds (where data electrode Dj is the anode and scan electrode SCi is the cathode) and discharge start voltage VFsd (where data electrode Dj is the cathode and scan electrode SCi is the anode).

In the sustain period of subfield SF1, voltage Vd is applied to data electrodes D1, D4, D7, . . . , Dr, . . . disposed at the discharge cells having red phosphors and data electrodes D3, D6, D9, . . . , Db, . . . disposed at the discharge cells having blue phosphors. Meanwhile, voltage 0(V) is applied to data electrodes D2, D5, D8, . . . , Dg, . . . disposed at the discharge cells having green phosphors. Voltage 0(V) is applied to sustain electrode SU1 through sustain electrode SUn, and sustain pulse voltage Vs is applied to scan electrode SC1 through scan electrode SCn. In the discharge cell having undergone an address discharge, difference between the voltage on scan electrode SCi and the voltage on sustain electrode SUi is calculated by adding voltage Vs to the difference between the wall voltage on scan electrode SCi and the wall voltage on sustain electrode SUi. The calculated value exceeds discharge start voltage VFss between scan electrode SCi and sustain electrode SUi, by which a sustain discharge is generated between scan electrode SCi and sustain electrode SUi. The sustain discharge produces ultraviolet rays, allowing phosphor layer 35 to emit light. Negative wall voltage is built up on scan electrode SCi, while positive wall voltage is built up on sustain electrode SUi and data electrode Dk. A discharge cell without an address discharge in the previous address period has no sustain discharge and therefore maintains the wall voltage the same as that at the completion of initializing operation.

Next, voltage 0(V) is applied to scan electrode SC1 through scan electrode SCn and sustain pulse voltage Vs is applied to sustain electrode SU1 through sustain electrode SUn. In a discharge cell having undergone a sustain discharge, a sustain discharge occurs again, by which phosphor layer 35 emits light. Through the discharge, negative wall voltage is built up on sustain electrode SUi and positive wall voltage is built up on scan electrode SCi. In this way, sustain pulses corresponding to luminance weight are alternately applied to scan electrode SC1 through scan electrode SCn and sustain electrode SU1 through sustain electrode SUn. This allows the sustain discharge to repeatedly occur in a discharge cell having undergone an address discharge.

In the erase period of subfield SF1, as is similar to the sustain period, voltage Vd is applied to data electrodes D1, D4, D7, . . . , Dr, . . . disposed at the discharge cells having red phosphors and data electrodes D3, D6, D9, . . . , Db, . . . disposed at the discharge cells having blue phosphors. Meanwhile, voltage 0(V) is applied to data electrodes D2, D5, D8, . . . , Dg, . . . disposed at the discharge cells having green phosphors. At the same time, voltage 0(V) is applied to sustain electrode SU1 through sustain electrode SUn, and a ramp waveform voltage with a gradual increase to voltage Vr is applied to scan electrode SC1 through scan electrode SCn. In the embodiment, voltage Vr is set to a value the same as voltage Vs. During the application of voltage above, a weak erase discharge occurs in a discharge cell having undergone a sustain discharge (where, if the sustain period is omitted, in a discharge cell having undergone an address discharge). The discharge weakens wall voltage on scan electrode SCi and sustain electrode SUi.

After that, voltage 0(V) is applied to data electrode D1 through data electrode Dm. At the same time, voltage Ve is applied to sustain electrode SU1 through sustain electrode SUn, and a ramp waveform voltage with a gradual decrease from voltage 0(V) toward voltage Vi is applied to scan electrode SC1 through scan electrode SCn. Voltage Vi has a value that equals to scan pulse voltage Va or slightly higher.

The application of voltage generates again a weak discharge in a discharge cell having undergone the aforementioned weak erase discharge. Through the discharge, an excessive amount of the wall voltage on scan electrode SCi, sustain electrode SUi, and data electrode Dk is discharged, so that a proper amount of wall voltage is left for the address operation. The erase operation is thus completed.

The operations carried out in subfield SF2 through subfield SF10 are similar—except for the number of sustain pulses—to that in subfield SF1.

According to the embodiment, in each erase period of all the subfields, an erase discharge generated only in a discharge cell having undergone an address discharge in the immediately preceding address period. That is, no discharge is generated in a discharge cell with absence of address discharge. Therefore, in a discharge cell responsible for displaying black, no discharge is generated.

According to the embodiment, each value of application voltage is set as follows: −260(V) for voltage Vi; −145(V) for voltage Vc; −280(V) for voltage Va; 200(V) for voltage Vs; 200(V) for voltage Vr; 20(V) for voltage Ve; and 60(V) for voltage Vd. The voltage values, however, are not limited to above and they should be determined to an optimum value according to discharge characteristics of the panel and specifications of the plasma display device.

Besides, each of discharge start voltage employed for panel 10 of the embodiment is measured by the method that will be described below. The discharge start voltage is different for different color of the phosphors. As for a discharge cell having red phosphors, discharge start voltage VFds between data electrodes and scan electrodes is 200±10(V) and discharge start voltage VFsd is 320±10(V). As for a discharge cell having green phosphors, discharge start voltage VFds between data electrodes and scan electrodes is 220±10(V) and discharge start voltage VFsd is 350±10(V). As for a discharge cell having blue phosphors, discharge start voltage VFds between data electrodes and scan electrodes is 200±10(V) and discharge start voltage VFsd is 330±10(V). Discharge start voltage VFss between scan electrodes and sustain electrodes has the following values: 250±10(V) for a discharge cell having red or blue phosphors; and 280±10(V) for a discharge cell having green phosphors.

In the embodiment, the low voltage side of sustain pulse voltage is 0(V) and the voltage to be applied to data electrodes in a sustain period is 0(V), so that first voltage V1 is 0(V). Besides, the low voltage side of scan pulse voltage is voltage Va and the low voltage side of data pulse voltage is 0(V), so that third voltage V3 is voltage Va. In consideration with variations in voltage VFds for each phosphor, the maximum value thereof is 230(V). When these values are substituted in the expression of condition 1: (V1−V3)≧VFds, (V1−V3)=−Va>the maximum value of voltage VFds, i.e., 280(V)>230(V). Therefore, condition 1 is satisfied in all of the discharge cells.

The high voltage side of sustain pulse voltage is voltage Vs and the voltage to be applied to data electrodes in a sustain period is 0(V), so that second voltage V2 is voltage Vs. In addition, the minimum value of the total of discharge start voltage VFsd and discharge start voltage VFds is 500(V). When these values are substituted in the expression of condition 2: (V2−V3)≦(VFds+Vfsd), (V2−V3)=Vs−Va<the minimum value of VFds+VFsd, i.e., 480(V)<500(V). Therefore, condition 2 is also satisfied in all of the discharge cells.

As is apparent from the voltage setting above, the voltage to be applied to the scan electrodes measures at least voltage Va (i.e. the low voltage side of scan pulse voltage) and at most voltage Vs (i.e. the high voltage side of sustain pulse voltage). In other words, the scan electrodes undergo application of voltage not less than voltage Va (on the low voltage side of scan pulse voltage) and not more than voltage Vs (on the high voltage side of sustain pulse voltage), by which a discharge cell having no address discharge has no light emission.

Besides, as is apparent from the above, when voltage Va is set at a low level that satisfies condition 1, the absolute value of scan pulse voltage Va on the low voltage side is larger than the absolute value of sustain pulse voltage Vs on the high voltage side, i.e., |Va|>|Vs|.

According to the embodiment, as described above, driving voltage waveforms; in particular, scan pulse voltage Va is determined so as to satisfy condition 1 and condition 2. Specifically, the erase discharge in the erase period is generated selectively in a discharge cell having undergone an address discharge immediately preceding address period, and application voltage to the scan electrodes is determined so as to satisfy the following conditions:

(V1−V3)≧VFds condition 1;

and

(V2−V3)≦(VFds+Vfsd) condition 2,

where,
V1 represents a first voltage calculated by subtracting a voltage applied to data electrode Dj from a voltage on the low voltage side of sustain pulses applied to scan electrode SCi in the sustain period;
V2 represents a second voltage calculated by subtracting a voltage applied to data electrode Dj from a voltage on the high voltage side of sustain pulses applied to scan electrode SCi in the sustain period;
V3 represents a third voltage calculated by subtracting a voltage on the low voltage side of data pulses applied to data electrode Dj from a voltage on the low voltage side of scan pulses applied to scan electrode SCi in the address period;
Vfds represents a discharge start voltage at a discharge generated between data electrode Dj as the anode and scan electrode SCi as the cathode; and
Vfsd represents a discharge start voltage at a discharge generated between data electrode Dj as the cathode and scan electrode SCi as the anode.

Employing the voltage setting above allows address operation to have stability in spite of omission of the all-cell initializing operation. The description below will explain the reason.

First, condition 1 will be described. For generating an address discharge, it is necessary to start a discharge between data electrode Dj and scan electrode SCi. To start the discharge with application of relatively low voltage Vda to data electrode Dj, a sufficient amount of positive wall voltage has to be built up on data electrode Dj so that a voltage about the same as discharge start voltage VFds is applied between data electrode Dj and scan electrode SCi at application of scan pulse to scan electrode SCi. According to the embodiment, as described above, the all-cell initializing operation is omitted and no discharge is generated in a discharge cell responsible for displaying black. That is, positive control of wall voltage cannot be expected, and therefore the amount of wall voltage of a discharge cell for displaying black is uncertain. However, if the discharge space contains charged particles even in a small amount, the charged particles move to each electrode so as to ease the electric field in the discharge space, and attach to the wall of a discharge cell to build up wall voltage thereon.

First, such built up wall voltage will be described. In a sustain period, a lot of charged particles are generated in a discharge cell having a sustain discharge and dispersed in the discharge space. It is presumable that the dispersion allows a small amount of charged particles to be carried in the space of a discharge cell that displays black with no sustain discharge. In the discharge cell for displaying black, through the application of voltage to scan electrode SCi, sustain electrode SUi, and data electrode Dj, wall voltage is slowly built up so as to lessen electric potential difference between the electrodes. In the process above, a voltage that wall voltage extremely gets close thereto (and finally settles thereon) is defined as “left-alone” wall voltage. If sustain pulses are continuously and alternately applied to scan electrode SCi and sustain electrode SUi, the “left-alone” wall voltage settles on a value between the high voltage side of the sustain pulse and the low voltage side thereof. Taking not only sustain pulses but also application of other driving voltage waveforms into account, the “left-alone” wall voltage of each discharge cell may be close to the low voltage side of sustain pulse voltage.

Besides, the “left-alone” wall voltage is largely affected by charging characteristics of phosphors applied in the discharge cells. The charging characteristics of the phosphors employed in the embodiment are as follows: +20(μC/g) for red phosphors; −30(μC/g) for green phosphors; and +10(μC/g) for blue phosphors. Only the green phosphors have a characteristic of charging in negative electric potential. This allows the “left-alone” wall voltage of the discharge cell having green phosphors to be lower than those having red phosphors and blue phosphors.

Next, the voltage in the discharge cells in the address period will be described. On data electrode Dj disposed at the discharge cell for displaying black, wall voltage is gradually built up toward the low voltage side of sustain pulse voltage or the “left-alone” wall voltage higher than the sustain pulse voltage. Scan pulse voltage Va of the embodiment satisfies condition 1, which therefore allows positive wall voltage enough for generating an address discharge to be built up on data electrode Dj. As a result, an address discharge can be generated without the all-cell initializing operation.

Besides, the wall voltage in a discharge cell for displaying black slowly gets close to the “left-alone” wall voltage. In an erase period, when a voltage calculated by adding wall voltage to the voltage between the data electrode and the scan electrode gets close to the discharge start voltage, dark current flows and lowers the wall voltage on data electrode Dj. It is considered that the dark current contributes to priming for encouraging an address discharge, so that a stable address discharge without significant delay in discharge is generated even in a discharge cell having displayed black.

As described above, setting driving voltage to be applied to each electrode—particularly, scan pulse voltage Va—to a low value so as to satisfy condition 1 allows wall voltage required for address operation to be built up without the all-cell initializing operation. At the same time, the voltage control above offers priming that contributes to a stable address discharge.

Next, condition 2 will be described. If scan pulse voltage Va is set to an excessive low value, an error discharge generates—regardless of presence or absence of address operation—at application of sustain pulse voltage Vs to scan electrode SCn, by which image display cannot be attained. To suppress the error discharge, the voltage between the data electrode and the scan electrode at application of sustain pulse voltage Vs has to be set to a value not greater than discharge start voltage VFsd. The voltage control is defined by condition 2.

According to the embodiment, the driving voltage waveforms are determined so as to satisfy condition 1 and condition 2 in all of the discharge cells. The voltage setting allows address operation to have stability with no all-cell initializing operation. At the same time, omitting the all-cell initializing operation eliminates light emission with no contribution to gradation display, enhancing sharpness of image.

Further, in the embodiment, the voltage applied to data electrode Dg at a discharge cell having green phosphors is set to 0(V), which is lower than voltage Vd applied to data electrodes Dr and data electrodes Db. Data electrodes Dr are disposed at the discharge cells having red phosphors, and data electrodes Db are disposed at the discharge cell having blue phosphors. Employing the voltage setting above allows voltage Va to have a broadened setting margin. Hereinafter, the reason will be explained.

When voltage Va is determined so as to satisfy condition 1 and condition 2, the setting range of it depends on discharge start voltage VFsd and discharge start voltage VFds. The discharge start voltage (i.e. voltage VFsd and voltage VFds) in a discharge cell having green phosphors tends to be higher than those in discharge cells having red phosphors and blue phosphors. Therefore, in a discharge cell having green phosphors, the setting range of scan pulse voltage Va has a shift toward the high voltage side. Besides, green phosphors have charging characteristics of negative voltage, which allows the wall voltage on data electrode Dg (disposed at the discharge cell having green phosphors) to be substantially lower than those on data electrode Dr and data electrode Db (disposed at the discharge cell having red phosphors and blue phosphors, respectively). The factors above encourage higher-side shifting of the setting range of voltage Va.

It will be understood that the actual setting range of voltage Va is an overlapping part of the setting ranges of scan pulse voltage Va of the discharge cells having the phosphors of red, green, and blue. That is, if the setting range of scan pulse voltage Va in only a discharge cell having green phosphors has a shift, the actual setting margin of scan pulse voltage Va gets narrow. In other words, eliminating variations in setting range of scan pulse voltage Va of discharge cells having each phosphor allows scan pulse voltage Va to have a broadened setting margin.

According to the embodiment, voltage 0(V), which is to be applied to data electrode Dg disposed at the discharge cell having green phosphors, is set lower at least than voltage Vd to be applied to data electrode Dr disposed at the discharge cell having red phosphors. This eliminates variations in setting range of scan pulse voltage Va to the discharge cells having each phosphor, so that scan pulse voltage Va has a broadened setting margin.

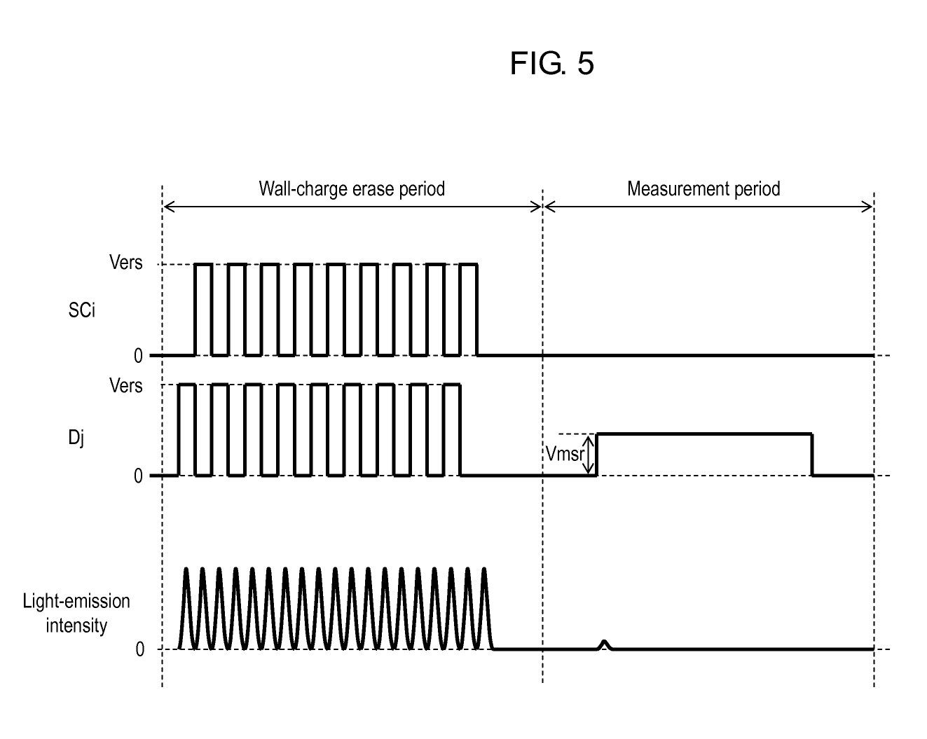

The discharge start voltage (i.e. voltage VFsd and voltage VFds) and the wall voltage can be measured, for example, by the method described in the following reference: “Measurement of a Plasma in the AC Plasma Display panel Using RF Capacitance and Microwave Techniques”, IEEE TRANSACTIONS ON ELECTRON DEVICES, Vol. ED-24, No. 7, July, 1977. As another usable way, a simplified measurement of discharge start voltage will be described below (see FIG. 5).

Prior to the measurement, wall charge is erased. Specifically, as is shown in the wall-charge erase period of FIG. 5, pulse voltage Vers that is much higher than the expected discharge start voltage is applied alternately between the electrodes to be measured, for example, between the data electrode and the scan electrode. Next, discharge start is detected. Specifically, as is shown in the measurement period of FIG. 5, pulse voltage Vmsr that is smaller than the expected discharge start voltage is applied to one of the aforementioned electrodes, for example, the data electrode to generate a discharge. With the application of voltage Vmsr, light emission accompanied by a discharge is detected by a photo sensor, such as Photomultiplier Tube. If a discharge is not observed, after wall charge is erased again in the wall-charge erase period, and then, in the measurement period, pulse voltage Vmsr with a slight increase in absolute value of the voltage is applied to the electrode to cause light emission. Of all the values of voltage Vmsr measured in the repeatedly carried out measurement period, the voltage having the minimum absolute value is the discharge start voltage. When voltage Vmsr applied in the measurement period is positive voltage, the measured voltage is discharge start voltage VFds between the data electrode as the anode and the scan electrode as the cathode. In contrast, when voltage Vmsr applied in the measurement period is negative voltage, the measured voltage is discharge start voltage VFsd between the data electrode as the cathode and the scan electrode as the anode.

Once the discharge start voltage is obtained, the wall voltage can be calculated as the difference between the discharge start voltage measured above and a voltage at which a discharge starts in a discharge cell with wall voltage built up therein.

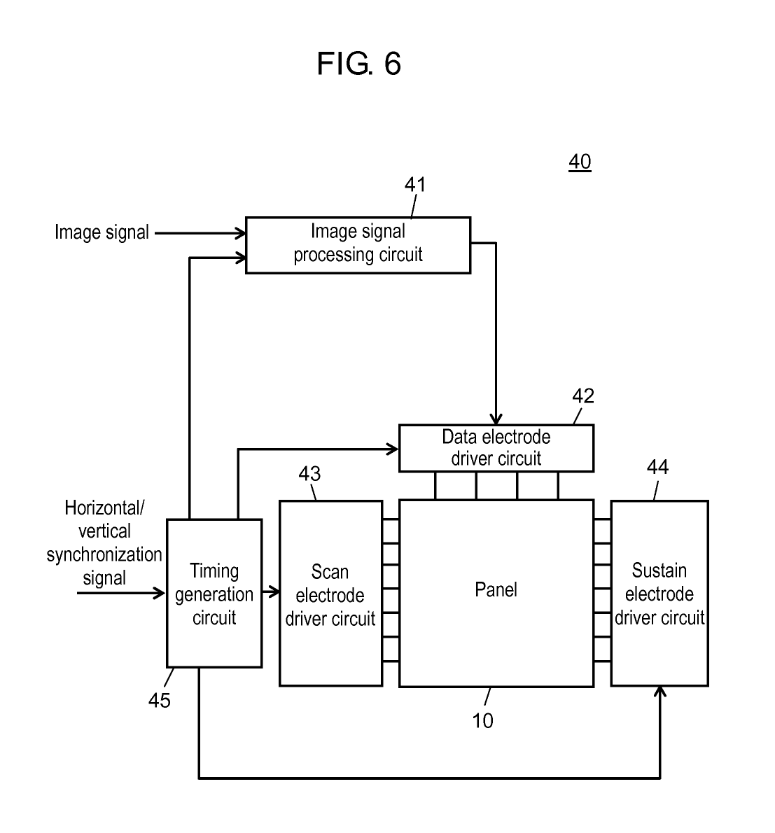

Next, the driver circuit for driving panel 10 will be described. FIG. 6 is a circuit block diagram of plasma display device 40 in accordance with first exemplary embodiment of the present invention. Plasma display device 40 has panel 10 and the driver circuit therefor. The driver circuit contains image signal processing circuit 41, data electrode driver circuit 42, scan electrode driver circuit 43, sustain electrode driver circuit 44, timing generation circuit 45, and an electric power supply circuit (not shown) for supplying electric power for each circuit block.

Receiving an image signal, image signal processing circuit 41 converts it into image data for light emitting or non light-emitting on a subfield basis. Data electrode driver circuit 42 converts the image data of each subfield into address pulses suitable for data electrode D1 through data electrode Dm and applies the pulses to them. Timing generation circuit 45 generates timing signals that control each circuit block according to a horizontal synchronization signal and a vertical synchronization signal, and the timing signals are fed to each circuit block. According to the timing signals, scan electrode driver circuit 43 generates the aforementioned driving voltage waveform and applies it to scan electrode SC1 through scan electrode SCn. Similarly, according to the timing signals, sustain electrode driver circuit 44 generates the aforementioned driving voltage waveform and applies it to sustain electrode SU1 through sustain electrode SUn.

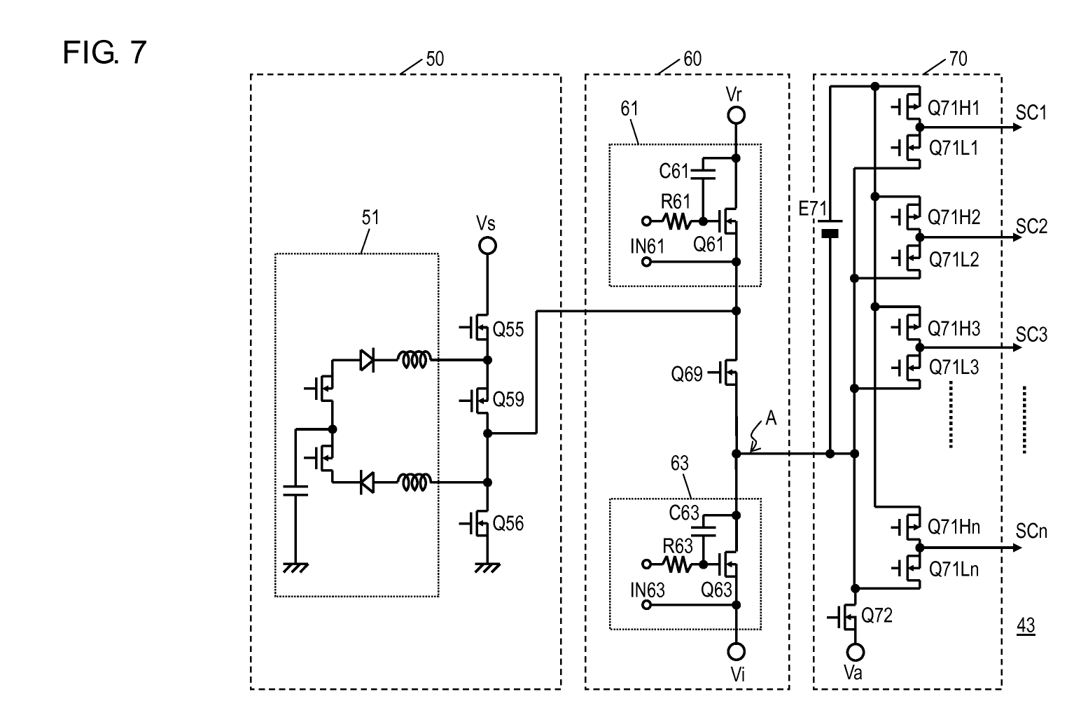

FIG. 7 is a circuit diagram of scan electrode driver circuit 43 of plasma display device 40 of first exemplary embodiment of the present invention. Scan electrode driver circuit 43 has sustain pulse generation circuit 50, ramp waveform voltage generation circuit 60, and scan pulse generation circuit 70.

Sustain pulse generation circuit 50, which has power recovery circuit 51, and switching elements Q55, switching elements Q56, switching elements Q59, generates sustain pulses to be applied to scan electrode SC1 through scan electrode SCn. Power recovery circuit 51 recovers electric power used for driving scan electrode SC1 through scan electrode SCn to reuse it. Switching element Q55 clamps scan electrode SC1 through scan electrode SCn to voltage Vs, switching element Q56 clamps scan electrode SC1 through scan electrode SCn to voltage 0(V). Switching element Q59 is a separation switch and prevents current backflow via a parasitic diode of a switching element that is a component of scan electrode driver circuit 43.

Scan pulse generation circuit 70 has switching element Q71H1 through switching element Q71Hn, switching element Q71L1 through switching element Q71Ln, and switching element Q72. Scan pulse generation circuit 70 generates scan pulses according to electric power supply of voltage Va and electric power supply E71 of voltage (Vc−Va) added on reference electric potential (i.e., the electric potential at node A shown in FIG. 7) of scan pulse generation circuit 70. The generated scan pulses are sequentially applied, as shown in FIG. 3, to scan electrode SC1 through scan electrode SCn. In sustain operation, scan pulse generation circuit 70 outputs an output voltage of sustain pulse generation circuit 50, i.e., the voltage at node A, to scan electrode SC1 through scan electrode SCn.

Ramp waveform voltage generation circuit 60 has Miller integrating circuits 61, Miller integrating circuits 63 and generates ramp waveform voltage shown in FIG. 3. Miller integrating circuit 61 has transistor Q61, capacitor C61, and resistor R61. With application of a fixed voltage to input terminal IN61, Miller integrating circuit 61 generates ramp waveform voltage with a gradual increase toward voltage Vr. Miller integrating circuit 63 has transistor Q63, capacitor C63, and resistor R63. With application of a predetermined voltage to input terminal IN63, Miller integrating circuit 63 generates ramp waveform voltage with a gradual decrease toward voltage Vi. Like switching element 59, switching element Q69 is a separation switch and prevents current backflow via a parasitic diode of a switching element that is a component of scan electrode driver circuit 43.

The switching elements and transistors may be formed of well known elements, such as MOSFET and IGBT. The switching elements and transistors are controlled by timing signals for each of the elements and transistors generated in timing generation circuit 45.

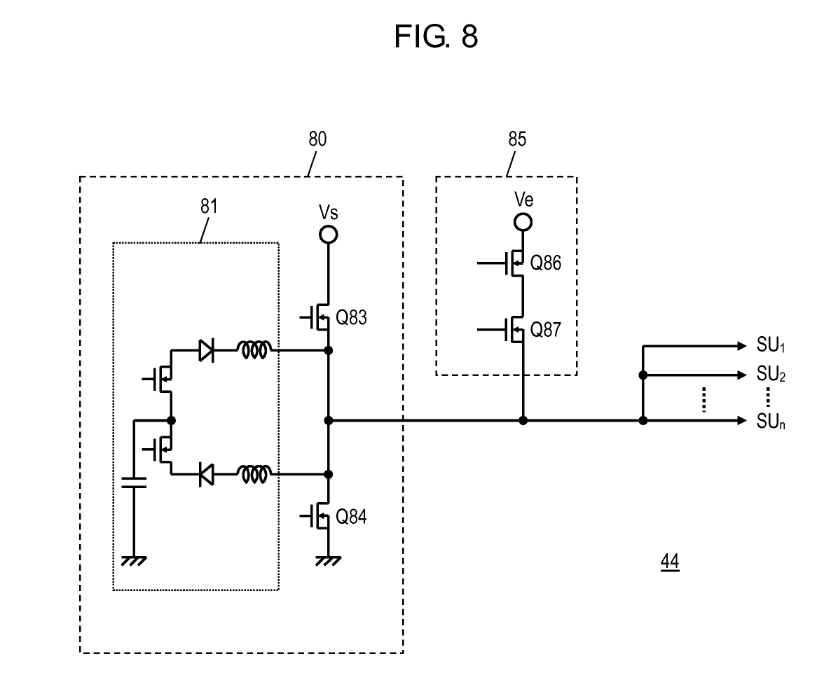

FIG. 8 is a circuit diagram of sustain electrode driver circuit 44 of plasma display device 40 in accordance with first exemplary embodiment of the present invention. Sustain electrode driver circuit 44 has sustain pulse generation circuit 80 and fixed voltage generation circuit 85.

Sustain pulse generation circuit 80, which has power recovery circuit 81, and switching elements Q83, switching elements Q84, generates sustain pulses to be applied to sustain electrode SU1 through sustain electrode SUn.

Power recovery circuit 81 recovers electric power used for driving sustain electrode SU1 through sustain electrode SUn to reuse it. Switching element Q83 clamps sustain electrode SU1 through sustain electrode SUn to voltage Vs, switching element Q84 clamps sustain electrode SU1 through sustain electrode SUn to voltage 0(V).

Fixed voltage generation circuit 85 has switching elements Q86, switching elements Q87 and applies voltage Ve to sustain electrode SU1 through sustain electrode SUn.

The switching elements above may be formed of well known elements, such as MOSFET and IGBT. The switching elements are controlled by timing signals for each of the elements generated in timing generation circuit 45.

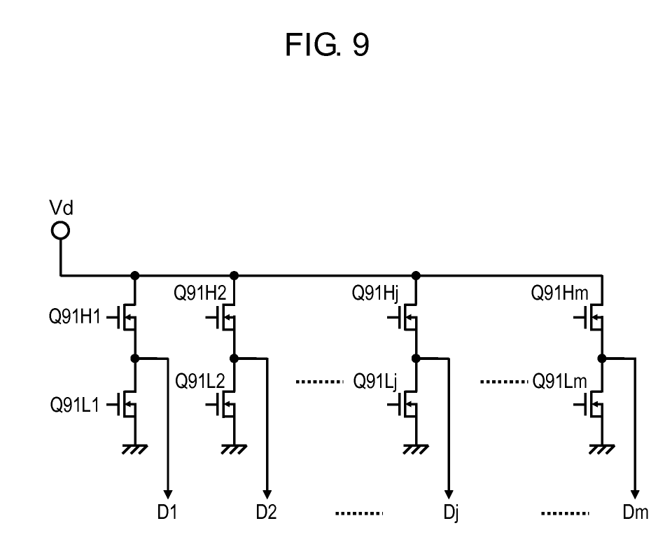

FIG. 9 is a circuit diagram of data electrode driver circuit 42 of plasma display device 40 in accordance with first exemplary embodiment of the present invention. Data electrode driver circuit 42 has switching elements Q91H1-Q91Hm, switching element Q91L1 through switching element Q91Lm. When switching element Q91Lj is turned on, voltage 0(V) is applied to data electrode Dj. When switching element Q91Hj is turned on, voltage Vd is applied to data electrode Dj.

In the sustain period of subfield SF1, to apply voltage Vd to data electrodes D1, D4, D7, . . . , Dr, . . . disposed at the discharge cells having red phosphors and data electrodes D3, D6, D9, . . . , Db, . . . disposed at the discharge cells having blue phosphors, switching elements Q91H1, Q91H4, Q91H7, . . . , Q91Hr, . . . and switching elements Q91H3, Q91H6, Q91H9, . . . , Q91Hb, . . . are turned ON, whereas switching elements Q91L1, Q91L4, Q91L7, . . . , Q91Lr, . . . and switching elements Q91L3, Q91L6, Q91L9, . . . , Q91Lb, . . . are turned OFF. To apply voltage 0(V) to data electrodes D2, D5, D8, . . . , Dg, . . . disposed at the discharge cells having green phosphors, switching elements Q91H2, Q91H5, Q91H8, . . . , Q91Hg, . . . are turned OFF, whereas switching elements Q91L2, Q91L5, Q91L8, . . . , Q91Lg, . . . are turned ON.

The driving voltage waveforms of the panel shown in FIG. 3 are generated by the driver circuits described above. However, the driver circuits shown in FIG. 6 through FIG. 9 are for purposes for illustration only and are not to intended to be limiting of the invention.

According to the panel driving method of the embodiment, as described above, applying scan pulses that satisfy the aforementioned conditions to the scan electrodes not only provides address operation with stability in spite of omitting the all-cell initializing operation, but also eliminates variations in driving voltage applied to each discharge cell, i.e., broadens the setting margin of driving voltage. As a result, the panel driving method allows a plasma display device to have improvement in contrast.

### Second Exemplary Embodiment

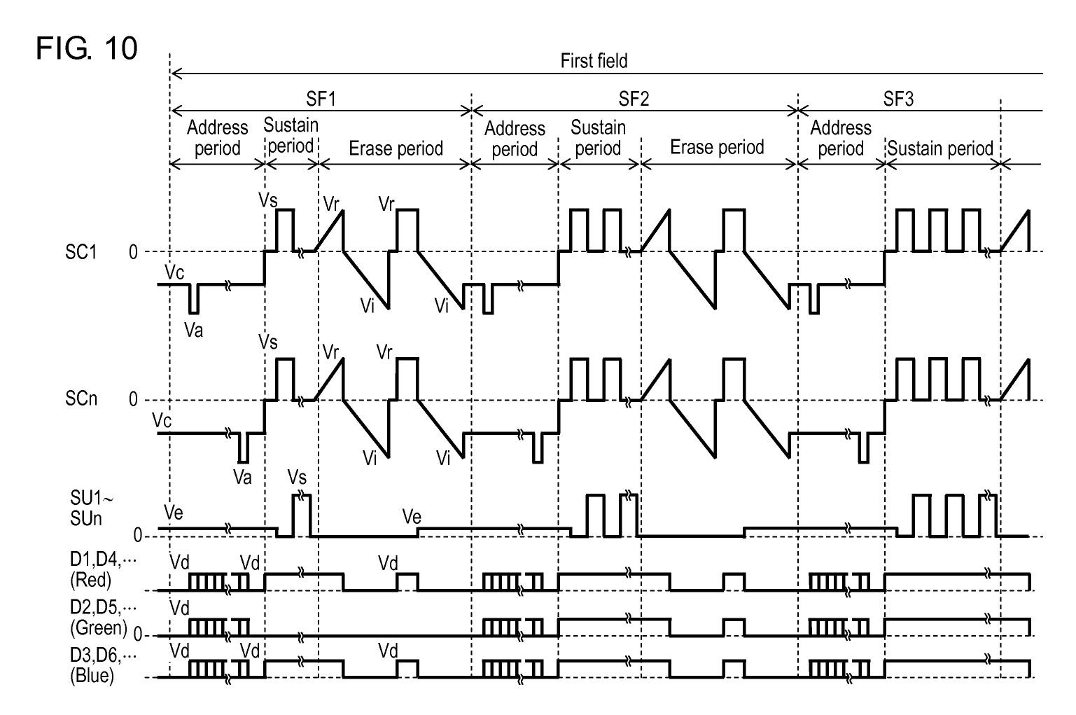

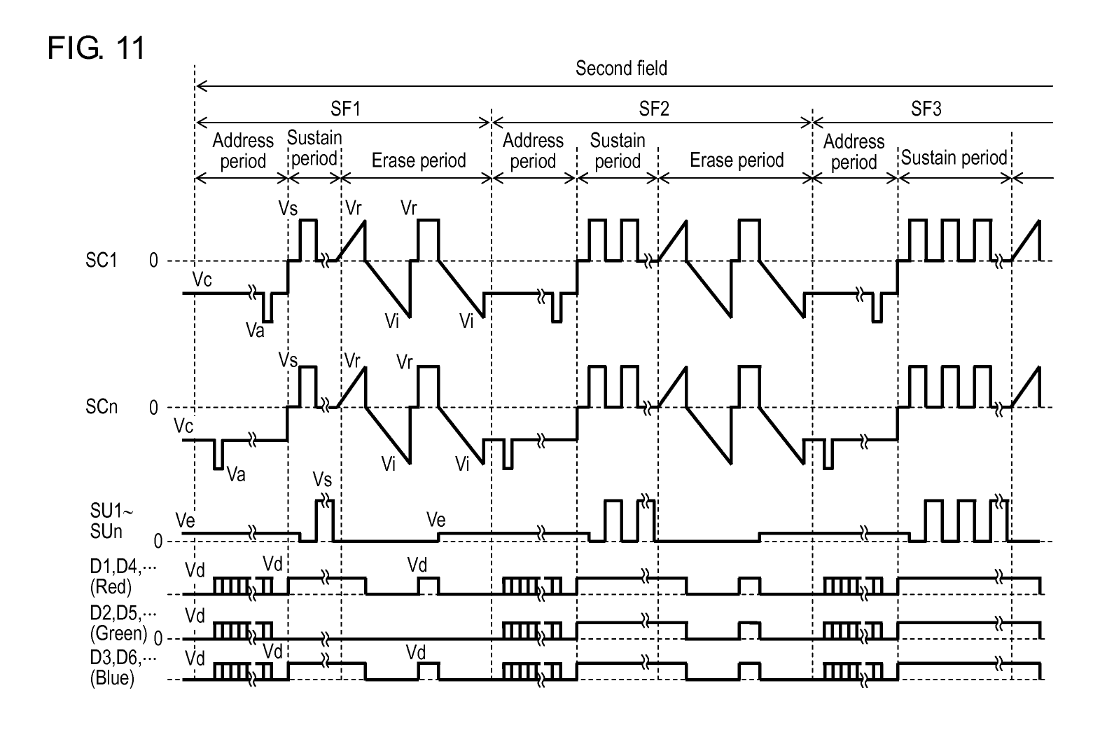

Hereinafter, another structure of the driving voltage waveforms of the present invention will be described with reference to drawings. FIG. 10 and FIG. 11 show the waveforms of driving voltage to be applied to each electrode of a plasma display device in accordance with second exemplary embodiment of the present invention. Specifically, FIG. 10 shows the driving voltage waveforms in the first field, whereas FIG. 11 shows the driving voltage waveforms in the second field. According to second exemplary embodiment, the panel is driven by employing alternately the first field and the second field. In the description of second exemplary embodiment, panel 10 having a structure similar to that described in first exemplary embodiment is driven on a method that employs a subfield structure similar to that described in first exemplary embodiment.

In the address period of subfield SF1 of the first field, voltage 0(V) is applied to data electrode D1 through data electrode Dm, voltage Ve is applied to sustain electrode SU1 through sustain electrode SUn, and voltage Vc is applied to scan electrode SC1 through scan electrode SCn. Next, scan pulse voltage Va is applied to scan electrode SC1 located in the first row, and address pulse voltage Vd is applied to data electrode Dk disposed at the discharge cell to be lit in the first row. Like in the first exemplary embodiment, voltage Va is determined so as to satisfy condition 1 and condition 2.

The application of voltage above generates an address discharge between data electrode Dk and scan electrode SC1, and between scan electrode SC1 and sustain electrode SU1. Through the address discharge, positive wall voltage is built up on scan electrode SC1, while negative wall voltage is built up on sustain electrode SU1 and data electrode Dk. As described above, an address discharge is generated so as to build up wall voltage on each electrode in a discharge cell to be lit in the first row. In contrast, the voltage at the intersection of scan electrode SC1 and the data electrode Dh with no application of the address pulse voltage is lower than the discharge start voltage, and therefore no address discharge is generated.

In this way, scan pulses are sequentially applied to the scan electrodes SC2, SC3, . . . , SCn-1, SCn in the second row through the n^{th} row. Through the application of scan pulses, the corresponding discharge cells in the first, second, third, . . . , (n-1)th, and n^{th} rows undergo address operation and build up wall voltage required for the sustain discharge in the next sustain period.

In the sustain period of subfield SF1, voltage Vd is applied to data electrodes D1, D4, D7, . . . , Dr, . . . disposed at the discharge cells having red phosphors and data electrodes D3, D6, D9, . . . , Db, . . . disposed at the discharge cells having blue phosphors. Meanwhile, voltage 0(V) is applied to data electrodes D2, D5, D8, . . . , Dg, . . . disposed at the discharge cells having green phosphors. Voltage 0(V) is applied to sustain electrode SU1 through sustain electrode SUn, and sustain pulse voltage Vs is applied to scan electrode SC1 through scan electrode SCn. In the discharge cell having undergone an address discharge, a sustain discharge is generated between scan electrode SCi and sustain electrode SUi. The sustain discharge produces ultraviolet rays, allowing phosphor layer 35 to emit light. Negative wall voltage is built up on scan electrode SCi, while positive wall voltage is built up on sustain electrode SUi and data electrode Dk. In contrast, a discharge cell without an address discharge in the previous address period has no sustain discharge and therefore maintains the wall voltage the same as that at the completion of initializing operation.

Next, voltage 0(V) is applied to scan electrode SC1 through scan electrode SCn, and sustain pulse voltage Vs is applied to sustain electrode SU1 through sustain electrode SUn. In a discharge cell having undergone a sustain discharge, a sustain discharge occurs again, by which phosphor layer 35 emits light. Through the discharge, negative wall voltage is built up on sustain electrode SUi, while positive wall voltage is built up on scan electrode SCi. In this way, sustain pulses corresponding to luminance weight are alternately applied to scan electrode SC1 through scan electrode SCn and sustain electrode SU1 through sustain electrode SUn. This allows the sustain discharge to repeatedly occur in a discharge cell having undergone an address discharge.

In the erase period of subfield SF1, as is similar to the sustain period, voltage Vd is applied to data electrodes D1, D4, D7, . . . , Dr, . . . disposed at the discharge cells having red phosphors and data electrodes D3, D6, D9, . . . , Db, . . . disposed at the discharge cells having blue phosphors. Meanwhile, voltage 0(V) is applied to data electrodes D2, D5, D8, . . . , Dg, . . . disposed at the discharge cells having green phosphors. At the same time, voltage 0(V) is applied to sustain electrode SU1 through sustain electrode SUn; meanwhile, a ramp waveform voltage with a gradual increase to voltage Vr is applied to scan electrode SC1 through scan electrode SCn. In the embodiment, voltage Vr is set to a value the same as voltage Vs. During the application of voltage above, a weak erase discharge occurs in a discharge cell having undergone a sustain discharge (or in a discharge cell having undergone an address discharge, if the sustain period is omitted). This is the first-time discharge generated between scan electrode SCi as the anode and sustain electrode SUi as the cathode. The discharge weakens wall voltage on scan electrode SCi and sustain electrode SUi.

Next, voltage 0(V) is applied to data electrode D1 through data electrode Dm. While voltage 0(V) is being applied to sustain electrode SU1 through sustain electrode SUn, a ramp waveform voltage with a gradual decrease from voltage 0(V) toward voltage Vi is applied to scan electrode SC1 through scan electrode SCn. The application of voltage generates again a weak discharge in a discharge cell having undergone the aforementioned weak erase discharge. The weak discharge above is the first-time discharge as a discharge generated between the scan electrode as the cathode and the data electrode as the anode.

After that, voltage Vd is applied to data electrodes D1, D4, D7, . . . , Dr, . . . disposed at the discharge cells having red phosphors and data electrodes D3, D6, D9, . . . , Db, . . . disposed at the discharge cells having blue phosphors; meanwhile, rectangular voltage Vr is applied to scan electrode SC1 through scan electrode SCn. The application of voltage generates the third-time discharge in a discharge cell having undergone the weak discharge above. The discharge is weak, too, and this is the second-time discharge as a discharge between the scan electrode as the anode and the sustain electrode as the cathode.

After that, voltage 0(V) is applied to data electrode D1 through data electrode Dm; meanwhile, voltage Ve is applied to sustain electrode SU1 through sustain electrode SUn, and a ramp waveform voltage with a gradual decrease from voltage 0(V) toward voltage Vi is applied to scan electrode SC1 through scan electrode SCn. The application of voltage generates the fourth-time discharge in a discharge cell having undergone a discharge. Through the weak discharge, an excessive amount of the wall voltage on scan electrode SCi, sustain electrode SUi, and data electrode Dk is discharged, so that a proper amount of wall voltage is left for the address operation. The erase operation is thus completed.

The operation in the address period of subfield SF2 that follows subfield SF1 is similar to that in the address period of subfield SF1 and therefore the description thereof will be omitted.

In the sustain period of subfield SF2, voltage Vd is applied to data electrode D1 through data electrode Dm of all of the discharge cells having phosphors of red, green, and blue. Meanwhile, sustain pulses corresponding to luminance weight are alternately applied to scan electrode SC1 through scan electrode SCn and sustain electrode SU1 through sustain electrode SUn. This allows a sustain discharge to repeatedly occur in a discharge cell having undergone an address discharge.

In the erase period of subfield SF2, voltage Vd is applied, as is in the sustain period, to data electrode D1 through data electrode Dm of all of the discharge cells. At the same time, voltage 0(V) is applied to sustain electrode SU1 through sustain electrode SUn; meanwhile, a ramp waveform voltage with a gradual increase to voltage Vr is applied to scan electrode SC1 through scan electrode SCn. The application of voltage above generates a weak erase discharge in a discharge cell having undergone a sustain discharge (or in a discharge cell having undergone an address discharge, if the sustain period is omitted). Next, voltage 0(V) is applied to data electrode D1 through data electrode Dm. While voltage 0(V) is being applied to sustain electrode SU1 through sustain electrode SUn, a ramp waveform voltage with a gradual decrease from voltage 0(V) toward voltage Vi is applied to scan electrode SC1 through scan electrode SCn. After that, voltage Vd is applied to data electrode D1 through data electrode Dm, and rectangular voltage Vr is applied to scan electrode SC1 through scan electrode SCn. Further, voltage 0(V) is applied to data electrode D1 through data electrode Dm, and voltage Ve is applied to sustain electrode SU1 through sustain electrode SUn. Meanwhile, a ramp waveform voltage with a gradual decrease from voltage 0(V) toward voltage Vi is applied to scan electrode SC1 through scan electrode SCn. Through the application of voltage, an excessive amount of the wall voltage on scan electrode SCi, sustain electrode SUi, and data electrode Dk is discharged, so that a proper amount of wall voltage is left for the address operation.

The operations carried out in subfield SF3 through subfield SF10 of the first field are similar to that in subfield SF2 of the first field, except for the number of sustain pulses.

In the address period of subfield SF1 of the second field, voltage 0(V) is applied to data electrode D1 through data electrode Dm, voltage Ve is applied to sustain electrode SU1 through sustain electrode SUn, and voltage Vc is applied to scan electrode SC1 through scan electrode SCn. Next, scan pulse voltage Va is applied to scan electrode SCn located in the nth row, and address pulse voltage Vd is applied to data electrode Dk disposed at the discharge cell to be lit. Like in the first exemplary embodiment, scan pulse voltage Va is determined so as to satisfy condition 1 and condition 2.

The application of voltage above generates an address discharge between data electrode Dk and scan electrode SCn, and between scan electrode SCn and sustain electrode SUn. In this way, address operation is carried out and wall voltage is built up on each electrode in a discharge cell to be lit in the n^{th} row.

Next, scan pulse voltage Va is applied to scan electrode SCn-1 in the (n-1)th row, and address pulse voltage Vd is applied to data electrode Dk disposed at the discharge cell to be lit. The application of voltage allows wall voltage to be built up on each electrode in the (n-1)^{th} row. In this way, address operation at the (n-1)^{th} row is carried out. In a like manner, scan pulses are sequentially applied to scan electrodes SCn-2, SCn-3, . . . , SC2, SC1 so that address operation is carried out from the (n-2)^{th} row to the first row.

In each address period of the subfields of the second field, as described above, scan pulses are sequentially applied to scan electrodes SCn, SCn-1, SCn-2, . . . , SC2, SC1 so that address operation is carried out in the discharge cells in the order of the n^{th}, (n-1)^{th}, (n-2)^{th}, . . . , second, first rows. That is, in each address period of the subfields of the second field, the address operation is carried out in the inverse order of that carried out in each address period of the subfields of the first field.

The operations in the sustain period and the erase period of subfield SF1 of the second field are similar to those of subfield SF1 of the first field. Besides, the operations carried out in subfield SF2 through subfield SF10 of the second field are similar to those in subfield SF2 through subfield SF10 of the first field, except for the inverse order of the address operation in the address period.

In this way, panel 10 is driven by the method where the first field and the second field are alternately employed.

To drive panel 10, the driving method of the embodiment uses alternately the first field and the second field. In the first field, scan pulses are sequentially applied to scan electrodes SC1 through SCn. In the second field, in contrast, scan pulses are sequentially applied to the scan electrodes in the inverse order; from SCn to SC1. Using alternately the first field and the second field, the driving method of the embodiment drives panel 10. The advantage of the structure will be described below, focusing on the operation at which an image signal requesting all black display switched into an image signal requesting all white display.

According to the embodiment, as described above, a discharge cell for displaying black has no discharge. The absence of discharge allows each discharge cell to have decrease in priming and therefore increase in discharge delay. The address operation in the condition above can further increase in discharge delay, thereby increasing discharge cells that fail in address discharge. Under the condition, however, if an address discharge is successfully carried out in a discharge cell, the priming generated in the discharge cell is dispersed around the cell. By virtue of the priming, the discharge cell waiting for address operation just after the discharge cell successfully having the address discharge has decrease in discharge delay, allowing the discharge cell to have a high probability of successful address discharge.

Here, suppose that the panel is driven by using the first field only. In the address period, scan pulses are always applied to scan electrodes SC1 to SCn, that is, always from the top to the bottom of the screen. Therefore, the discharge cells, which are downwardly adjacent to the discharge cell successfully having the address discharge, also have an address discharge, so that the black display can be switched into the white display. In contrast, discharge cells located upper than the discharge cell successfully having the address discharge receive no priming, and therefore successful address discharge cannot be expected. This takes time to switch the screen from black to white in the upper part of the screen, resulting in degradation of image display quality.

Now, suppose that the panel is driven by using the second field only. In the address period, scan pulses are always applied to scan electrodes SCn to SC1, that is, always from the bottom to the top of the screen. In the lower part of the screen, it takes time to switch the screen from black to white, resulting in degradation of image quality.

According to the embodiment, however, the panel is driven by switching alternately between the first field and the second field. This allows the panel to have quick switching into white all over the screen.

Besides, in the sustain period of subfield SF1 of the embodiment, voltage 0(V), which is to be applied to data electrode Dg disposed at the discharge cell having green phosphors, is set lower than voltage Vd to be applied to data electrode Dr and data electrode Db that are disposed at the discharge cells having red phosphors and blue phosphors, respectively. As is in first exemplary embodiment, voltage 0(V) to be applied to data electrode Dg disposed at the discharge cell having green phosphors is set lower at least than voltage Vd to be applied to data electrode Dr disposed at the discharge cell having red phosphors. This eliminates variations in setting range of scan pulse voltage Va to discharge cells having each phosphor, so that scan pulse voltage Va has a broadened setting margin.

According to the embodiment, as described above, a discharge cell for displaying black has no discharge. Due to the absence of discharge, the discharge start voltage of the discharge cell for displaying black tends to be substantially higher than those of the discharge cells for displaying gradation other than black. Therefore, compared to discharge cells to be lit, the setting range of voltage Va that satisfies condition 1 and condition 2 in the discharge cell for displaying black has a shift on the high voltage side. To eliminate in variations in voltage setting of voltage Va, a voltage setting—in which voltage 0(V) to be applied to data electrode Dh disposed at the discharge cell for displaying black is set lower than voltage Vd to be applied to data electrode Dk disposed at the discharge cell for displaying other gradations—is effective in eliminating variations in voltage setting of voltage Va. This can contribute to a broadened setting margin of voltage Va. However, instead of the method above, the embodiment employs the following voltage setting. That is, voltage 0(V) to be applied to data electrode Dg in the sustain period of subfield SF1 having the minimum luminance weight is set lower than voltage Vd to be applied to data electrode Dg in the sustain period of the subfields of subfield SF2 through subfield SF10 (i.e. other than subfield SF1 having the minimum luminance weight).

According to the embodiment, the gradation display is attained by the coding where the combination of subfields to be lit is formed of subfields with luminance weight as small as possible. This is a technique for suppressing dynamic false contour, and a detailed explanation thereof is described in, for example, Unexamined Japanese Patent Publication No. 2008-197430. According to the coding, the probability of light emission becomes higher in a subfield having smaller luminance weight. Particularly, as for the discharge cell that has displayed black, it is likely to have dark gradation display. In that case, it is very likely that the address discharge in such a discharge cell is generated in subfield SF1 with the minimum luminance weight. Considering above, the method of the embodiment employs the voltage setting as follows: voltage 0(V), which is to be applied to data electrode Dg in the sustain period of subfield SF1 with the minimum luminance weight, is set lower than voltage Vd to be applied to data electrode Dg in each sustain period of subfield SF2 through subfield SF10. This eliminates variations in setting range of voltage Va to be applied to each discharge cell, broadening the actual setting margin of voltage Va.

As for a discharge cell for displaying high level of gradation, the setting range of voltage Va in subfield SF1 has a shift on the low voltage side. This may increase the probability that a discharge cell emitting light with high luminance has error discharge in subfield SF1. However, as described above, subfield SF1 has the minimum luminance weight. Such an error discharge generated in the discharge cell has no contribution to degradation of image display quality.

According to the embodiment, as described above, in the sustain period of subfield SF1 as the subfield having the minimum luminance weight, the voltage to be applied to data electrode Dg disposed at the discharge cell having green phosphors is set lower than the voltage to be applied to data electrode Dr and data electrode Db that are disposed at the discharge cells having red phosphors and blue phosphors, respectively; and at the same time, the voltage to be applied to data electrode Dg disposed at the discharge cell having green phosphors is set lower than the voltage to be applied to data electrodes in each sustain period of subfield SF2 through subfield SF10 except for subfield SF1 as the subfield having the minimum luminance weight.

Further, according to the embodiment, the erase period has erase operation in the following sequence:
generating a discharge as the first-time discharge between sustain electrode SUi as the cathode and scan electrode SCi as the anode;
generating a discharge as the first-time discharge between scan electrode SCi as the cathode and data electrode Dj as the anode;
generating a discharge as the second-time discharge between sustain electrode SUi as the cathode and scan electrode SCi as the anode; and
generating a discharge as the second-time discharge between scan electrode SCi as the cathode and data electrode Dj as the anode.

Besides, to reduce the intensity of the discharges above and suppress light emission therewith, voltage is applied to the sustain electrode and the scan electrode in the following sequence:
applying voltage 0(V) to sustain electrode SUi; meanwhile, applying ramp waveform voltage with a gradual increase to scan electrode SCi,
applying ramp waveform voltage with a gradual decrease to scan electrode SCi,
applying positive rectangular voltage to scan electrode SCi, and
applying voltage Ve, which is greater than voltage 0(V), to sustain electrode SUi; meanwhile, applying descending ramp waveform voltage to scan electrode SCi.

As described above, generating a weak discharge repeatedly—without a strong discharge—allows each electrode to have a sufficient amount of wall voltage thereon, generating an address discharge with stability.

Besides, numeric values shown in first exemplary embodiment and second exemplary embodiment are cited merely by way of example and without limitation; they should be properly determined according to characteristics of a panel and specifications of a plasma display device.

### INDUSTRIAL APPLICABILITY

The structure of the present invention eliminates variations in setting range of driving voltage to be applied to each discharge cell, broadening the setting margin of the driving voltage. At the same time, the structure eliminates light emission having no contribution to gradation display by omitting the all-cell initializing operation, while maintaining the stability of address operation. As a result, drastic improvement in contrast is obtained. The features above are useful for a panel driving method and for a plasma display device.

### REFERENCE MARKS IN THE DRAWINGS

10 panel
22 scan electrode
23 sustain electrode
24 display electrode pair
32 data electrode
35 phosphor layer
40 plasma display device
41 image signal processing circuit
42 data electrode drive circuit
43 scan electrode driver circuit
44 sustain electrode driver circuit
45 timing generation circuit
50,80 sustain pulse generation circuit
51,81 power recovery circuit
60 ramp waveform voltage generation circuit
61,63 Miller integrating circuit
70 scan pulse generation circuit
85 fixed voltage generation circuit

1. A method for driving a plasma display panel having a plurality of discharge cells, each of the discharge cells including a scan electrode, a sustain electrode, a data electrode, and a phosphor emitting light of red, green, or blue color,
wherein, one filed is formed by a plurality of subfields, each of the subfields having:
an address period where a scan pulse is applied to the scan electrode, and an address pulse is applied to the data electrode, for generating an address discharge;
a sustain period where a voltage is applied to the data electrode, a sustain pulse corresponding to luminance weight is applied alternately to the scan electrode and the sustain electrode, for generating a sustain discharge; and
an erase period where a predetermined voltage is applied to the scan electrode and the sustain electrode, for generating an erase discharge, the method comprising:
generating selectively the erase discharge in the erase period, only in the discharge cell having undergone the address discharge in the immediately preceding address period; and
controlling a voltage to be applied to the data electrode of the discharge cell having the phosphor emitting light of green so as to be lower than a voltage to be applied to the data electrode of the discharge cell having the phosphor emitting light of red in the sustain period of at least one of the subfields.

2. A method for driving a plasma display panel having a plurality of discharge cells, each of the discharge cells including a scan electrode, a sustain electrode, and a data electrode,
wherein, one filed is formed by a plurality of subfields, each of the subfields having:
an address period where a scan pulse is applied to the scan electrode, and an address pulse is applied to the data electrode for generating an address discharge;
a sustain period where a voltage is applied to the data electrode, a sustain pulse corresponding to luminance weight is applied alternately to the scan electrode and the sustain electrode, for generating a sustain discharge; and
an erase period where a predetermined voltage is applied to the scan electrode and the sustain electrode, for generating an erase discharge, the method comprising:
generating selectively the erase discharge in the erase period, only in the discharge cell having undergone the address discharge in the immediately preceding address period; and
controlling a voltage to be applied to the data electrode in the sustain period of the subfield having the minimum luminance weight so as to be lower than a voltage to be applied to the data electrode in the sustain period of each subfield except for the subfield having the minimum luminance weight.

3. The method for driving a plasma display panel of claim 1, wherein the voltage to be applied to the data electrode of the discharge cell having the phosphor emitting light of green in the sustain period of the subfield having the minimum luminance weight is lower not only than a voltage to be applied to the data electrode of the discharge cell having the phosphor emitting light of red in the sustain period of the subfield having minimum luminance weight but also than a voltage to be applied to the data electrode in the sustain period of each subfield except for the subfield having the minimum luminance weight.

4. A plasma display device comprising:
a plasma display panel having a plurality of discharge cells, each of the discharge cells including a scan electrode, a sustain electrode, and a phosphor emitting light of red, green, or blue color; and
a driver circuit for generating driving voltage waveforms and applying the driving voltage waveforms to each electrode of the plasma display panel,
wherein, one filed is formed by a plurality of subfields, each of the subfields having:
an address period where a scan pulse is applied to the scan electrode, and an address pulse is applied to the data electrode, for generating an address discharge;
a sustain period where a voltage is applied to the data electrode, a sustain pulse corresponding to luminance weight is applied alternately to the scan electrode and the sustain electrode, for generating a sustain discharge; and
an erase period where a predetermined voltage is applied to the scan electrode and the sustain electrode, for generating an erase discharge,
wherein, the driver circuit generates the erase discharge selectively in the discharge cell having undergone the address discharge in the immediately preceding address period for driving the plasma display panel, and in the sustain period of at least one of the subfields, the driver circuit controls a voltage to be applied to the data electrode of the discharge cell having the phosphor emitting light of green so as to be lower than a voltage to be applied to the data electrode of the discharge cell having the phosphor emitting light of red.

5. A plasma display device comprising:
a plasma display panel having a plurality of discharge cells, each of the discharge cells including a scan electrode, and a sustain electrode; and
a driver circuit for generating driving voltage waveforms and applying the driving voltage waveforms to each electrode of the plasma display panel,
wherein, one filed is formed by a plurality of subfields, each of the subfields having:
an address period where a scan pulse is applied to the scan electrode, and an address pulse is applied to the data electrode, for generating an address discharge;
a sustain period where a voltage is applied to the data electrode, a sustain pulse corresponding to luminance weight is applied alternately to the scan electrode and the sustain electrode, for generating a sustain discharge; and
an erase period where a predetermined voltage is applied to the scan electrode and the sustain electrode, for generating an erase discharge,
wherein, the driver circuit generates the erase discharge selectively in the discharge cell having undergone the address discharge in the immediately preceding address period for driving the plasma display panel, and in the sustain period of the subfield having the minimum luminance weight, the driver circuit controls a voltage to be applied to the data electrode so as to be lower than a voltage to be applied to the data electrode in the sustain period of each subfield except for the subfield having the minimum luminance weight.
